(19) United States
(12) Patent Application Publication
(10) Pub. No.: US 2022/0142196 A1
(43) Pub. Date: May 12, 2022

(54) DAIRY-FREE CHOCOLATE CONFECTIONS AND METHOD OF MAKING

(71) Applicant: The Hershey Company, Hershey, PA (US)

(72) Inventors: Gagan MONGIA, Hershey, PA (US); Xiaoying WANG, Hummelstown, PA (US); Craig N. RANK, Harrisburg, PA (US)

(21) Appl. No.: 17/607,101

(22) PCT Filed: May 1, 2020
(86) PCT No.: PCT/US2020/031005

§ 371 Date: Oct. 28, 2021

Related U.S. Application Data
(60) Provisional application No. 62/842,119, filed on May 2, 2019.

(51) Int. Cl. A23G 1/40; A23G 1/48; A23G 1/36

(52) U.S. Cl. CPC A23G 1/40; A23V 2002/00; A23G 1/36; A23G 1/48

(57) ABSTRACT

A dairy-free and vegan chocolate confection and method of making the same are disclosed. In the confection of the invention, the milk solids present in traditional milk chocolate are replaced by grain flour. The grain flour is roasted or heat treated to impart desirable flavor and texture characteristics to the confection

### FIELD OF THE INVENTION

This application is directed to the manufacture of confectionery products and more particularly to the manufacture of dairy-free chocolate confections and chocolate candy.

### BACKGROUND OF THE INVENTION

The recognition of the benefits of, and consumer preferences for, vegan and dairy free diets are on the rise. Lactose, a sugar found in dairy, has long been recognized as problematic for some individuals. Many children under the age of 18 suffer from food allergies.

There are reports of significant improvements of children's sleep patterns, behavior, language, focus and eye contact when allergy prone foods are removed from the diet.

Those with dairy intolerances usually fall into one of two groups: either lactose intolerance or casein sensitivity. It is estimated that between 30-50 million Americans are lactose intolerant. Certain ethnic and racial populations are more affected than others. For example, almost all Asians are lactose intolerant. Lactose intolerance is the inability to digest significant amounts of lactose, the major sugar found in dairy products/milk. Lactose intolerance is caused by a shortage of the enzyme lactase, which is produced by the cells that line the small intestine. Lactase is responsible for breaking milk sugar into two simpler forms of sugar called glucose and galactose which are then absorbed into the blood stream. Symptoms can be controlled through diet by limiting their lactose ingestion. People differ in the amounts and types of foods they can tolerate. Researchers have identified a genetic link for lactose intolerance. Casein is one of the primary proteins in cow's milk and like lactose intolerance, individuals differ in the amount of casein they can tolerate.

Individuals who must avoid milk due to an allergy, lactose intolerance, or as part of a vegan diet will need to eliminate milk chocolate. Many of these individuals desire a product with the same taste and pleasing mouthfeel as milk chocolate but without the dairy ingredients. To date, the confectionery industry has been unsuccessful in meeting consumer expectations in this regard.

Traditional chocolate making methods are well known and involve several basic steps carried out in a particular order. Generally, the process starts with cocoa beans harvested from pods of fruit that grow on the cacao tree. The cocoa beans are removed from the pods and placed in large piles to ferment, during which the shells of the beans harden and darken, and a rich cocoa flavor develops.

Dried cocoa beans are roasted at very high temperatures and hulled to separate the shell from the inside of the bean, also called a “nib,” the part of the bean used to make chocolate. The nibs are milled by a grinding process that turns the nibs into a liquid called chocolate liquor. The chocolate liquor, which may be separated in advance into its constituents, cocoa butter and cocoa powder, is mixed with a sweetener, usually sugar, and in the case of milk chocolate, milk solids are also added.

The mixture is refined and then conched, a process in which the chocolate powder is maintained above the fat melting temperature while mixing elements smooth out gritty particles, remove moisture and off-flavors, and develop pleasant flavors. Conching also releases fat, increasing fat coating on particles so that the chocolate has a proper fluidity for further processing. Additional fat is added to achieve the full formulated fat content and emulsifiers are also added to reduce viscosity and enhance fluidity of the chocolate paste. The liquid chocolate paste is tempered and then poured or deposited into a mold to produce a chocolate bar or used for enrobed products.

Consumers with allergies to dairy ingredients or who otherwise desire to exclude dairy and/or animal-based ingredients from their diets seek a chocolate confection that does not contain the milk solids present in milk chocolates made according to the traditional method. These consumers seek a chocolate confection that possesses many of the same tastes, mouth feel and properties of traditional milk chocolate but without dairy or animal products. Chocolate manufacturers seeking to produce dairy-free chocolate confections require a product that has favorable processability and rheological properties similar to milk chocolate. The ingredients for producing such dairy free confections must also be readily available and cost effective.

Others have used solids derived from nuts and oil seeds as a replacement for milk solids to produce vegan and dairy free chocolate confections. Incorporation of these replacement solids, however, has not been very successful in commercial products since they have a negative impact on the texture and mouthfeel of the chocolate. Confections comprising solids derived from nuts and oil seeds are waxy, chewy and slow to melt in the mouth. Similarly, the use of grain flour and syrup solids derived from grain are also seen in existing chocolate confections. These ingredients also negatively impact the mouthfeel of the chocolate confections in a similar way as solids from oil seeds and nuts.

Accordingly, there is a need for a dairy-free, plant-based chocolate confection that possesses the taste, texture and feel of a typical milk chocolate, is economical to produce, and has favorable processability and rheological properties when compared to existing dairy-free “milk” chocolate confections.

### SUMMARY

In general terms, the present disclosure is directed to a dairy-free substitute for the nonfat dairy solids normally used in the manufacture of milk chocolate, methods of making the dairy free substitute, methods of producing dairy-free chocolate confections, and the confections themselves. In a chocolate confection that ordinarily contains nonfat milk solids, a dairy free substitute of this disclosure can replace some or all of the nonfat milk solids in the confection.

According to aspects of the present disclosure, the dairy free substitute is a roasted grain flour prepared by dry heating (referred to herein as “roasting”) a flour derived from a raw grain for a predefined time and a predefined temperature. The roasted grain flour may then be used in a chocolate confection in place of nonfat milk solids. The current invention uses a roasting process to overcome the negative impact on texture that occurs when a non-cocoa, non-dairy solids component is used in chocolate confection products. It has been unexpectedly discovered that substituting roasted grain flour for milk solids in a typical milk chocolate confection formulation provides a texture, mouthfeel, processability and flavor much closer to traditional milk chocolate than other known substitutions, including unroasted grain flour.

According to aspects of this disclosure, an edible, dairy-free chocolate confection is described, comprising roasted grain flour, a cocoa component, a sweetener, and a plant origin fat. According to aspects of the invention, the roasted grain flour is prepared using a dry heat treatment process that causes raw grain flour to undergo a measurable change to at least one of color, flavor, and moisture content. In embodiments, the endpoint of the roasting process can be determined by measuring a color change of the grain flour or by empirically determining a desired internal temperature for the roasted grain flour.

### BRIEF DESCRIPTION OF THE DRAWINGS

For a more complete understanding of the present invention, reference is made to the following detailed description of an embodiment considered in conjunction with the accompanying drawings, in which:

FIG. 1 is a diagram showing the method of making a dairy-free chocolate confection according to an embodiment of the claimed invention.

FIG. 2 is a diagram showing the effect on viscosity of cooking flour in water for roasted and unroasted rice flour.

FIG. 3 is a diagram comparing the particle size distribution, upon grinding in a confection suspension, of roasted and unroasted rice flour.

### DETAILED DESCRIPTION OF THE INVENTION

Disclosed herein are dairy-free chocolate confections wherein the milk solids present in standard milk chocolate have been replaced by roasted grain flour. Methods of preparing the confections and the roasted grain flour are also disclosed. It has been unexpectedly discovered that using roasted grain flour as a substitute for dairy solids produces chocolate confections with improved organoleptic and rheological properties over known dairy-free chocolates, including those containing unroasted grain flour as a substitute for milk solids.

The following disclosure is presented to provide an illustration of the general principles of the present invention and is not meant to limit, in any way, the inventive concepts contained herein. Moreover, the features described in this section can be used in combination with the other described features in each of the multitude of possible permutations and combinations contained herein.

All terms defined herein should be afforded their broadest possible interpretations, including any implied meanings as dictated by a reading of the specification as well as any words that a person having skill in the art and/or a dictionary, treatise, or similar authority would assign particular meaning. Further, it should be noted that, as recited in the specification and in the claims appended hereto, the singular forms “a,” “an,” and “the” include the plural referents unless otherwise stated. Additionally, the terms “comprises” and “comprising” when used herein specify that certain features are present in that embodiment, but should not be interpreted to preclude the presence or addition of additional features, components, operations, and/or groups thereof.

The following disclosure is intended to be read in connection with the accompanying drawings, which are to be considered part of the entire written description of the invention. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The term “grain flour” as used in the specification and claims refers to the powder made by milling or grinding raw grains. “Raw grain” as used herein refers to grain that has not been germinated or malted. The term “unroasted grain flour” as used in the specification and claims refers to flour that has not been roasted, cooked or subjected to heat treatment other than the minimal heat treatment used by grain producers and flour mills to destroy pest organisms. The term “roasted grain flour” as used in the specification and claims refers to an unroasted grain flour that has been processed through the application of direct or indirect heat sufficient to cause the grain flour to undergo a measurable change to at least one of moisture content, flavor or color.

The term “syrup solids” as used in the specification and claims refers to a sweetener syrup from which the water content has been partially removed.

The term “dairy-free chocolate” as used in the specification and claims is intended to refer to a chocolate confection that is substantially free of dairy ingredients, or any other animal origin ingredients. The term “substantially free” as used in the specification and claims means less than 1 percent by weight.

The term “dairy ingredients” or “milk ingredients” as used in the specification refers to any dairy product (i.e., milk produced by a mammal) that is added to traditional milk chocolate. Examples of milk ingredients include, but are not limited to, nonfat milk solids, cream, milk fat (including anhydrous milk fat), milk (which may be concentrated, sweetened condensed, evaporated, dried), skim milk (which may be concentrated, sweetened condensed, evaporated, dried, nonfat), or buttermilk (concentrated or dried).

The term “milk chocolate” or “traditional milk chocolate” or “typical milk chocolate”, as used in the specification and claims, refers to a milk chocolate having diary ingredients.

The term “sweetener” as used in the specification and claims comprises nutritive sweeteners, including, but not limited to, sugar, dextrose, fruit sugar and the like. The term “sweetener” also comprises high potency nutritive sweeteners, low-calorie nutritive sweeteners and the like. The term “sweetener” also comprises non-nutritive sweeteners or a combination of nutritive and non-nutritive sweeteners.

The term “cocoa component” as used in the specification and claims refers to any ingredient obtained from a cocoa bean, including, but not limited to, cocoa liquor, cocoa powder, cocoa solids and combinations thereof. It is noted that some cocoa components, including cocoa powder and cocoa liquor, comprise cocoa butter in part, but in the formulations described herein, this cocoa butter constituent is treated as a cocoa component.

The terms “plant origin fat,” “plant-based fat,” vegetable oil” and “vegetable fat” as used in the specification and claims refer to any fat or oil extracted from seeds, nuts, fruits or vegetables, including cocoa butter. In the formulations described herein, where cocoa butter is used as the plant origin fat, it is in addition to any cocoa butter contained in the cocoa component.

The term “emulsifier,” as used in the specification and claims, is intended to refer to an ingredient that impacts fluidity of the milk chocolate.

The terms “flavor” and “flavorings” as used in the specification and claims, are intended to refer to any natural flavorings, excluding those flavors which alone or in combination mimic milk flavors or chocolate flavors.

The dairy-free chocolate confections of the claimed invention comprise a roasted grain flour component, a cocoa component, a sweetener and a plant origin fat. Other optional ingredients include flavorings and emulsifiers.

### The Roasted Grain Flour Component

The roasted grain flour component is made by roasting a grain flour produced by milling a raw grain. The raw grain must not be germinated or malted, since these processes alter the composition and properties of the raw grain. Preferred raw grains used to create the roasted grain flour component include, but are not limited to, corn, rice, wheat, oat, sorghum, millet and the like. Preferred grain flours include wheat, oat and rice flours. A more preferred grain flour is rice flour.

Unroasted grain flour is roasted through the application of direct or indirect heat, for example, heat from radiant, microwave, solar, and/or convection sources, in the presence or absence of moisture. Roasting is any heat processing that causes the raw grain flour to undergo a measurable change in at least one of moisture, flavor, or color. Grain flours having varying degree of roasting can be selected to suit a particular application. For example, a more extensively roasted grain flour will impart more intense flavor to the confection than a lighter roasted grain flour. In embodiments, the degree of roasting is expressed in terms of the internal temperature to which the grain flour is heated, the time of processing during the roasting process, a color change produced in the grain by the roasting process and combinations thereof.

In an embodiment, roasted grain flour is produced by heating unroasted grain flour to an internal temperature of between 180 to 450 Fahrenheit (82 to 232 degrees Celsius), preferably from 120 to 200 degrees Celsius, more preferably from 140 to 180 degrees Celsius. Mixing the grain flour during the heating step is preferred to achieve a uniformly roasted product. The heating of the grain flour can be achieved in a common oven or through large commercial food approved heating equipment. The roasting process may be performed using any equipment type that achieves sufficient change in the grain flour's physical properties, including but not limited to, moisture content, color and oil-binding capacity. Preferably, the sufficient degree of roasting is determined empirically based on the desired effect to the rheological properties, texture, and mouth feel when the roasted grain flour is used in chocolate confections to replace the nonfat milk solids present in traditional milk chocolate.

Roasting the grain flour results in a dairy-free chocolate confection with a mouthfeel and melted texture similar to a traditional milk chocolate confection. Dairy-free chocolate confections using unroasted grain flour as a substitute for nonfat milk solids in traditional milk chocolate formulations produces a confection with a claggy mouthfeel and a thick and highly viscous property to melted chocolate in the mouth.

The roasting allows for improved flavor development in the confection. Roasting also reduces the capacity of grain flour to bind/absorb fat and thereby reduces the amount of fat required to achieve the rheological properties required for manufacturing operations. The relative quantity of grain flour used can vary depending on the rest of the formulation and desired final confection.

The roasted grain flour component may optionally include syrup solids in combination with roasted grain flour. The degree of polymerization (or DE) in the syrup solids will allow for lowering of sugar amounts in the confection while the carbohydrate content will remain the same.

In an embodiment of a dairy-free chocolate confection where the sweetener is a nutritive sweetener, the roasted grain flour component comprises from 1 to 75 percent by weight of the confection. Preferably, the roasted grain flour component comprises from 1 to 35 percent, more preferably from 4 to 25 percent, most preferably from 7 to 17 percent by weight of the confection.

### Cocoa Component

Embodiments of the dairy-free chocolate confection may be made using any form of cocoa ingredients in any combination. Suitable cocoa components include natural coca solids, cocoa liquor, alkalized or dutched cocoa powder, other cocoa derived ingredients and combinations thereof. The cocoa component may be treated by fermentation and may be sourced from different origin cacao. In embodiments, preferred cocoa components comprise natural cocoa powder, cocoa liquor and combinations thereof.

In embodiments of a dairy-free chocolate confection formulation where the sweetener is a nutritive sweetener, the cocoa component comprises from 5 to 50 percent by weight of the chocolate confection, preferably from 12 to 35 percent by weight, more preferably from 18 to 27 percent by weight of the chocolate composition.

### Sweetener

The dairy-free chocolate confection may be made using a wide variety of sweeteners. The sweetener may be a nutritive sweetener, a non-nutritive sweetener or combinations thereof. Suitable sweeteners include, but are not limited to: common sugars, including, but not limited to sucrose, fructose, glucose, maltose, corn syrup solids and the like;

sugar alcohols including, but not limited to maltitol, sorbitol, erythritol and the like; rare sugars including, but not limited to Allulose, Tagatose and the like; and high intensity sweeteners, including, but not limited to aspartame, stevia and stevia extracts, sucralose and the like. A preferred sweetener is sucrose. In embodiments of a dairy-free chocolate confection formulation where the sweetener is a nutritive sweetener, the sweetener comprises from 25 to 70 percent by weight of the confection, more preferably from 35 to 60 percent by weight, more preferably from 40 to 55 percent by weight of the dairy-free chocolate confection.

### Plant Origin Fat

The plant origin fat is any fat not derived from an animal source. Preferred plant origin fats include, but are not limited to, cocoa butter, palm oil, palm kernel oil, coconut oil, shea butter, illepe fat, mango kernel oil, sal oil or any of their fractions or a combination thereof. A more preferred plant origin fat comprises cocoa butter. In an embodiment of a dairy-free chocolate confection where the sweetener is a nutritive sweetener, the plant origin fat comprises 5 to 50 percent by weight, preferably from 10 to 30 percent by weight, more preferably from 15 to 25 percent by weight of the dairy-free chocolate confection.

### Other Optional Ingredients

Other optional ingredients in the dairy-free chocolate confection may include flavorings, salt, emulsifiers and other additives commonly used in the art. A preferred flavoring is natural vanillin. Optionally, inclusions, including but not limited to, nuts, dried fruits, puffed grains, creams fillings and combinations thereof may be used in the dairy-free chocolate confection.

Examples of suitable emulsifiers may be any of those typically used in the art and include, but are not limited to lecithin, polyglycerol polyricinoleate, ammonium phosphatide, or combinations thereof. The emulsifier is preferably present at a maximum level of 1% of any one emulsifier or any mixture of emulsifiers, although one of skill in the art will recognize that more or less emulsifier may be employed depending on the combination of fat and emulsifier used. A preferred emulsifier is lecithin.

In embodiments, the confection is free of emulsifiers such as polyglycerol polyricinoleate, ammonium phosphatide and citric acid esters. In an embodiment of a dairy-free chocolate confection where the sweetener is a nutritive sweetener, an emulsifier comprises from 0.01 to 1.0 percent by weight of the dairy-free chocolate confection, preferably between 0.15 and 0.75 percent by weight and more preferably from 0.25 to 0.60 percent by weight.

### Method of Making Roasted Grain Flour

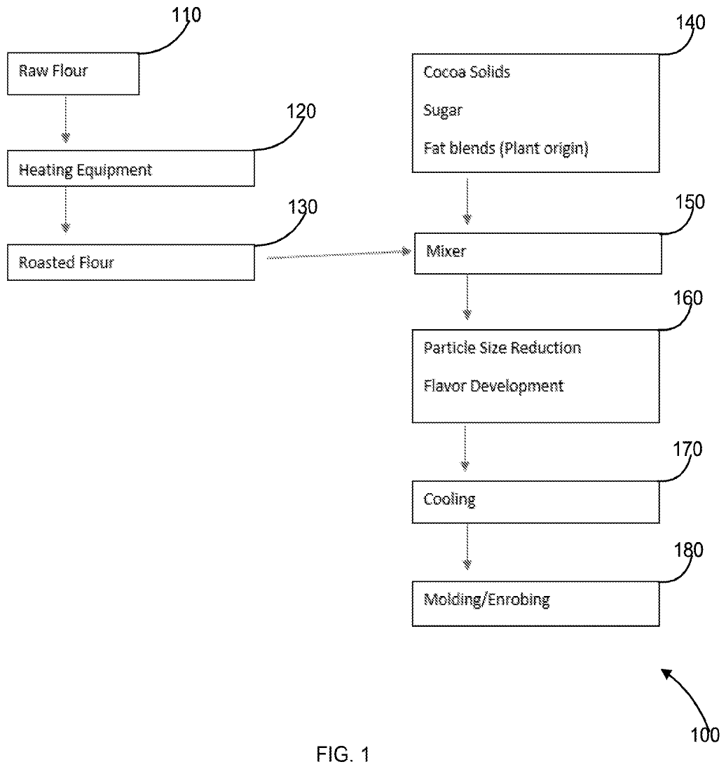

One skilled in the art will recognize that the method and degree of roasting may vary depending on the type of grain flour used, the type of end product being produced and the desired flavors and texture to be imparted to the dairy-free chocolate confection. FIG. 1 is a flow diagram of an embodiment of the method for preparing a dairy-free chocolate confection 100. Referring to the FIG. 1, unroasted grain flour 110 is placed in a heating apparatus 120. Roasting is accomplished by applying heat to the unroasted grain flour at a predetermined temperature for a predetermined time to produce a roasted grain flour 130. In another embodiment, roasting proceeds until a desired color change or moisture reduction is achieved in the flour. In an embodiment the heating apparatus is heated to a temperature of from 120 to 300 degrees Celsius, preferably from 140 to 270 degrees Celsius, more preferably from 160 to 240 degrees Celsius.

In an embodiment, the roasting is performed for one continuous period of time, or for a plurality of discontinuous periods of time, wherein the one continuous period of time or a sum of the plurality of discontinuous periods of time is between 10 minutes and 120 minutes. In an embodiment the roasting is performed until the grain flour reaches an endpoint temperature from 180 to 450 Fahrenheit (82 to 232 degrees Celsius), preferably from 120 to 200 degrees Celsius, more preferably from 160 to 180 degrees Celsius. A preferred endpoint grain flour temperature for a lightly roasted rice grain flour is 147 degrees Celsius. A preferred endpoint grain flour temperature for a darker roasted rice flour is 163 degrees Celsius.

Preferably, the grain is roasted in the presence of moving heated air in the head space above the grain flour. In other preferred embodiments, the grain flour is roasted using an apparatus and technique selected from the group consisting of static oven roasting, fluidized bed (vibrating conveyer) roasting, air roasting, fluidized bed roasting, drum roasting, oven roasting, rotary tray roasting, coffee roasting and combinations thereof.

In embodiments, the endpoint of the roasting process is determined when the grain flour undergoes a desired degree of color change. The color change may be determined by the human eye or, preferably, by a color measurement instrument, including but not limited to, a colorimeter. Preferably, the roasted grain flour has a color change corresponding to an increase in a and b values and decrease of L values on the Hunter Lab Color Scale (Hunter Associate Laboratory, Inc, Reston, Va.). In a preferred embodiment, an unroasted rice flour with Hunter Lab Color Scale L/a/b values of 88/0/8 is roasted until an endpoint is reached where the roasted rice flour has an “a” value ranging from 1 to 6, a “b” value ranging from 15 to 21, and an L value ranging from 72 to 84. The color changes can be measured by any instrument capable of measuring Hunter Lab Color Scale values.

When the grain flour has been roasted to the desired endpoint, the roasted grain flour is allowed to cool to ambient temperature. If the grain flour is not to be used immediately, it is stored in a sealed container to reduce moisture absorption. In an embodiment, the moisture content of the roasted grain flour is less than 5 percent by weight, preferably less than 3% and more preferably less than 2% by weight.

### Method of Making a Dairy-Free Chocolate Confection

The dairy-free chocolate confection of the claimed invention can be prepared using known methods of chocolate preparation. Referring to FIG. 1, in an embodiment, the roasted grain flour 130 is combined with the remaining dry ingredients (sweetener, cocoa component component) and approximately two-thirds of the plant origin fat 140 in a mixer 150. The mixture of dry ingredients and plant origin fat is refined 160 using any known refining method to yield a mean particle size of the roasted grain flour ranging from 5 to 45 microns, preferably 5 to 25 microns, more preferably 10 to 20 microns. After sufficient refining, the remaining one-third of the plant origin fat is added to the refined ingredients and mixed using a suitable mixing technique, at a temperature of approximately 50 degrees Celsius for a period of between 0.5 and up to 24 hours. The mixture is then cooled 170 to be tempered as needed and molded into desired confection molds 180.

In another embodiment, all of the ingredients (roasted grain flour component, sweetener, cocoa component and plant origin fat) are placed simultaneously into a mélange mixer and mixed for up to 24 hours to produce a dairy-free chocolate confection. Preferably the mélange mixer temperature is controllable set between 35 and 75 degrees Celsius, preferably between 40 and 70 degrees Celsius, more preferably between 45 and 60 degree Celsius.

In another embodiment, fat and nonfat solids ingredients are mixed in a ball mill to reduce the particle size of solids to a predetermined extent. The milled mix is than standardized to a composition and viscosity with the addition of fat and emulsifiers. The finished paste is then tempered as needed and applied to product by molding or enrobing.

The dairy-free chocolate confections of the present invention have superior taste, mouthfeel, texture, rheological properties and processability, as illustrated in the examples which follow. Without being bound to any particular theory, it is believed that physical and/or chemical changes that occur to the grain flour particles during the roasting process produce an ingredient that is a much more effective substitute for nonfat dairy solids in a traditional milk chocolate formulation than unroasted grain flour. Among the changes known to occur by roasting the grain flour are changes in the viscosity of the resulting chocolate compositions, changes in the particle size distribution of the grain flour in the resulting chocolate compositions and changes in the oil binding capacity of the grain flour. It is believed that these changes are responsible for the favorable results achieved using roasted grain flour as a substitute for dairy solids.

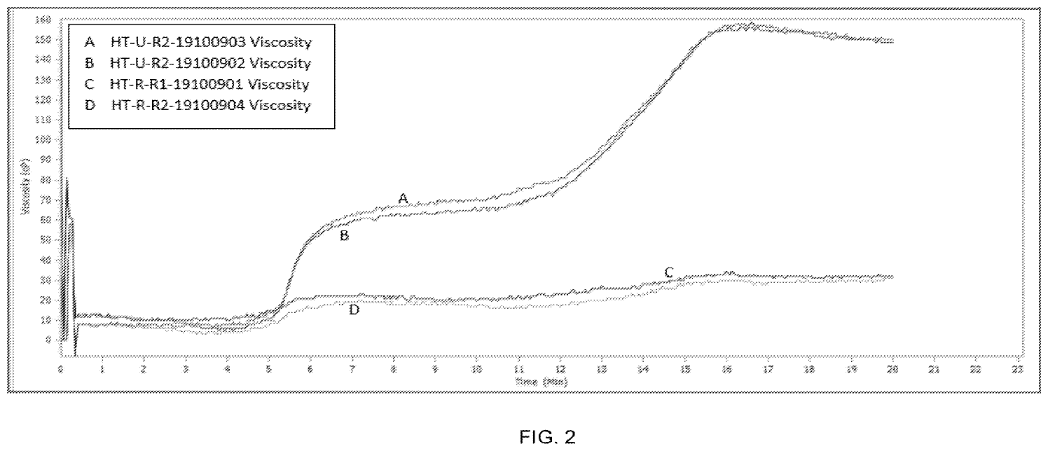

FIG. 2 is a diagram showing the effect on viscosity of cooking a suspension of rice flour in water for roasted flour compared to unroasted flour. Four 5 percent by weight suspensions of flour in water were prepared, two replicates of unroasted flour (samples A and B) and two replicates of roasted flour (samples C and D). The suspensions were heated while viscosity measurements were taken over 20 minutes using a Rapid Visco Analyzer (RVA) (Perten Instruments, Stockholm, Sweden). The curves for the unroasted flour (A and B) show the typical effect on viscosity upon cooking flour in water. The suspensions of uncooked flour showed significant increase in viscosity over time. In contrast, the curves for the roasted flour (C and D) are much flatter, corresponding to much smaller change in viscosity over cooking time. FIG. 2 shows that the roasted flour has a significantly decreased ability to react with water compared to unroasted flour. Without being bound to a particular theory, it is believed that this is one factor contributing to the superior rheological properties and mouthfeel of dairy-free chocolate confections prepared with roasted grain flour as compared to confections prepared with unroasted flour.

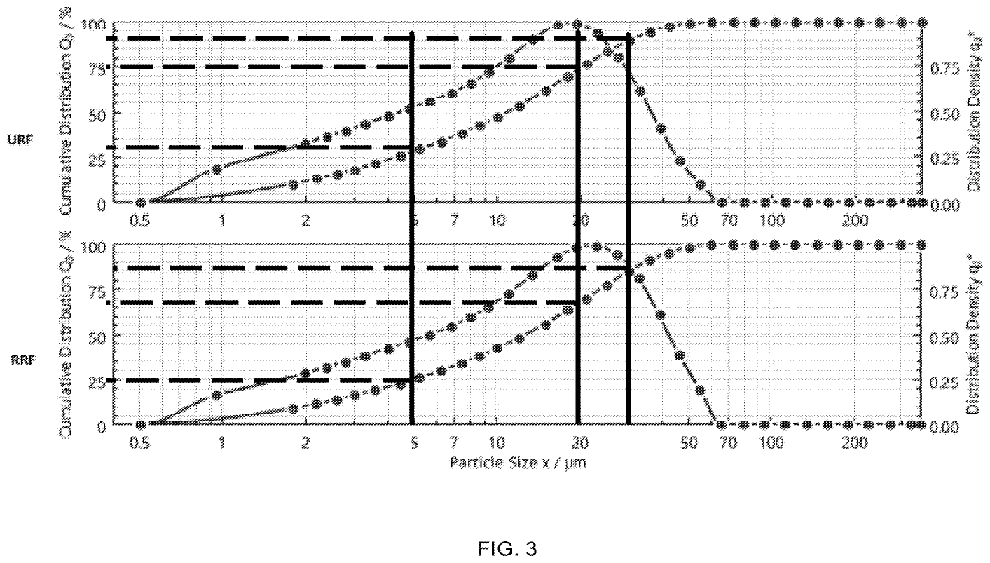

FIG. 3 is a diagram comparing the particle size distribution, upon grinding in a dairy-free chocolate confection suspension, of roasted rice flour and unroasted rice flour. The suspensions were prepared according to the formula and method of Example 4 below. The grinding of the roasted and unroasted flours was performed under identical conditions. Referring to FIG. 3, the upper graph corresponds to unroasted rice flour (URF) and the lower graph corresponds to roasted rice flour (RRF). Each graph shows the particle size cumulative distribution on the left y-axis and distribution density on the right y-axis. The curves show that the unroasted flour (URF) has a greater amount of fine particles. For example, the roasted rice flour has 25 percent of the particles at a particle size of 5 micrometers or less, whereas, for the unroasted flour, the percentage is 30 percent. Without being bound to a particular theory, it is believed that the greater number of fines in the contributes to a thicker, less pleasing, mouthfeel for suspensions containing unroasted flour compared to roasted flour.

The following examples illustrate specific embodiments of the invention described in this disclosure. As would be apparent to skilled artisans, various changes and modifications are possible and are contemplated within the scope of the invention described. The following examples should not be construed, in any way, to limit the scope of the invention.

### Example 1—Roasted Grain Flour Preparation

Two batches of unroasted rice flour, prepared from raw rice grains, were placed into a vibrating cylindrical tube with hot air circulation and roasted as listed in Table 1. In each case 600 g to 700 g of unroasted rice flour was used in a pilot scale roaster to achieve a specific color change, moisture reduction and aroma change in the rice flour. The “min/control” sample in Table 1 refers to a control sample of the base material (unroasted rice flour) which was used as the starting material for the other two treatments. A colorimeter was used to take color measurements of the roasted grain flours and control sample. Color values expressed herein refer to coordinates using the Hunter Labs Color Scale.

TABLE 1
Preparation of Roasted Rice Flour (Color endpoint)

| | Internal | Roasting | | Color—Hunter Labs | | |
|---|---|---|---|---|---|---|
| Roast | Temp. | Time | Moisture | Color Scale | | |
| Level | (Celsius) | (minutes) | (percent) | L-value | a-value | b-value |
| Min/ | — | 0 | 9.1 | 88 | 0 | 8 |
| control | | | | | | |
| (1) Low | 147 | 60 | 1.5 | 84 | 1 | 15 |
| roast | | | | | | |
| (2) High | 163 | 51 | 1.8 | 72 | 6 | 21 |
| roast | | | | | | |

Batch 1 was heated for 1 hour until the flour reached an internal temperature of 147 degrees Celsius after 60 minutes. The resulting roasted flour number 1 had a cream color and was categorized as a low roasted flour. Batch 2 was heated for 51 minutes until the flour reached an internal temperature of 163 degrees Celsius. The resulting roasted flour number 2 had a dark brown color and was categorized as a high roasted flour.

### Example 2 Dairy-Free Chocolate Confections using Roasted Grain Flours

Five samples were prepared according to the formulations listed in Table 2a, where the percentages are listed as percent by weight and absolute weight, respectively.

TABLE 2
Dairy-Free Chocolate Confection Formulations (weight percent).

| | | 2 | | 4 | 5 |
|---|---|---|---|---|---|
| | 1 | Rice and | 3 | Corn | Nonfat Dry |
| | Wheat | Wheat | Rice | Starch | Milk |
| | W10 | R8W2 | R10 | C10 | M10 |
| Fill/Flour | 8% | 5% | 8% | 4% | 8% |
| Cocoa Powder (Natural) | 8% | 8% | 8% | 8% | 8% |
| Sugar (sucrose) | 50% | 52% | 50% | 52% | 50% |
| Fat (plant-based fat | 34% | 35% | 34% | 35% | 34% |
| blend) | | | | | |
| TOTAL | 100% | 100% | 100% | 100% | 100% |

Samples 1, 2 and 3 were prepared using roasted grain flours as the fill/flour ingredient. In sample 4, the fill/flour ingredient was corn starch, and in sample 5, nonfat dry milk solids were used as the fill flour ingredient. The plant-based fat component was a mixture of two proprietary plant-based fat blends. The sugar component was sucrose and the cocoa component was natural cocoa powder.

The formulations were prepared using a traditional chocolate manufacturing process. Mixing and batching of part of the fat with all the nonfat solids was performed to create a mix that was processed in a chocolate refiner for particle size reduction. The remaining fat was added to the refined mix and the paste is mixed at a temperature of 50 to 60 degrees Celsius for 3 hours. The emulsifiers were added at this stage and mixing continued for another 30 minutes. The liquified paste was poured out and cooled to conditions needed for molding the confection.

The resulting dairy free chocolate confections were taste-tested alongside milk chocolate produced using the traditional method. The dairy free chocolate confections prepared using the roasted grain flours (samples 1-3) were found to have a taste, texture and mouthfeel more comparable to the traditional milk chocolate (sample 5) than the confection prepared with corn starch (sample 4).

### Example 3—Roasted Rice Flour Preparation (Thermal Endpoint)

Rice flour was roasted in pilot scale equipment using a batch process. The roasting vessel comprised a cylindrical stainless steel tube with the two ends of the tube sealed with removable covers. Ports in the covers allowed attachment of air tubes and measurement probes. The tube was placed on a vibrating platform that allowed both vertical and horizontal vibration. The tube was wrapped with heating elements on the outside surface to provide the heat needed for roasting. A port in an end cover was attached to a hot air source. Hot air flow was directed over the product during the roasting of the product. Two ports in the end cover were attached to temperature probes and configured to measure air and product temperatures during the roasting process. A port provided at the top of the tube was used to load the rice flour into the tube. The top port was left unsealed to allow hot air and moisture to flow out of the tube during the roasting process.

The roasting tube was pre-heated to a temperature of 400 degrees Fahrenheit (204 degrees Celsius). Hot air at a temperature of 300 degrees Fahrenheit (149 degrees Celsius) was introduced into the tube at a constant flow rate. The vibration system was started to ensure that a balance of vertical and horizontal vibration was conveyed to the tube. A 750 gram batch of rice flour obtained from a grain mill was added to the tube through the loading port at the top.

The rice flour was milled from a raw grain that had not been germinated or malted. Product and air temperatures were monitored using the probes in the tube. Roasting proceeded until an internal temperature of the grain flour reached 320 degrees Fahrenheit (160 degrees Celsius). This temperature was achieved in approximately 35 minutes. Heating and air flow were turned off and the roasted rice flour was removed by opening the front end cover of the tube. The roasted rice flour was cooled in a tray to ambient temperature and stored in a food safe container until use.

### Example 4—Dairy-Free Chocolate Confection Suspensions Using Rice Flour

Working examples of the present invention were prepared according to the formulation of Table 3. The confections were prepared in the form of suspensions of solids in fat.

TABLE 3
Chocolate Confection Suspension Using Rice Flour

| INGREDIENT | Batch (g) | Weight % |
|---|---|---|
| Sucrose | 470.40 | 47.04% |
| Cocoa Liquor | 194.70 | 19.47% |
| Cocoa Powder | 30.00 | 3.00% |
| Plant Origin Fat | 200.00 | 20.00% |
| (Cocoa Butter) | | |
| Rice flour | 100.00 | 10.00% |
| Lecithin | 4.50 | 0.45% |
| Flavor (vanillin) | 0.40 | 0.04% |
| TOTALS | 1000.0 | 100.00% |

Confection suspensions were prepared according to the formulation of Table 3, wherein all of the rice flour in a given confection was either roasted or unroasted. The roasted rice flour was prepared following the procedure of Example 3.

Chocolate confection suspensions were prepared using a melanger process to accomplish both the grinding and conching process steps of the traditional chocolate making process. The ingredients were weighed out according to the formula in Table 3. The cocoa butter and cocoa liquor were melted at a temperature of between 40 to 60 degrees Celsius. The melted cocoa butter and liquor were placed in the melanger and the machine was started so that the grinding wheels were turning freely on the base stone. Rice flour was added slowly, using a dosing system, in incremental amounts to the melanger. Mixing and grinding continued for about 60 minutes after all flour had been added. The cocoa powder was then added to the mixture in the melanger and mixing and grinding were continued for 30 minutes. Sugar was then added slowly, using a dosing system, in incremental amounts to the melanger. Half of the amount of lecithin was added to the mixture and grinding and mixing continued for 4 hours. Half of the remaining amount of lecithin was added to the mixture and mixing and grinding continued until a target particle size was obtained. The remaining lecithin and flavor were added to the mixture and mixing and grinding were continued for one hour. The resulting suspension was poured out of melanger for use and evaluation.

All ingredients, quantities and preparation steps were the same for the two series of confections, with the only difference being whether the rice flour used was roasted or unroasted. The physical and organoleptic properties of the confections were measured to study the effects of roasting the flour on the finished confection. The results of the testing are summarized in Table 4.

TABLE 4
Properties of Chocolate Confection Suspensions Prepared
Using Roasted/Unroasted Rice Flours.

| | Property Measured | | | | |
|---|---|---|---|---|---|
| | | | Mean | Rheology | |
| | Moisture | Fat | Particle Size | (40 deg. C.) | |
| | Method Used | | | | |
| | Karl | | | | Yield |
| | Fischer | Mojonier | Micrometer | Viscosity | Value |
| | Unit | | | | |
| | | | | | dynes/ |
| | percent | percent | micron | centiPoise | cmsq |
| Roasted Rice | 0.60 | 31.44 | 15 | 2194 | 164 |
| Flour | | | | | |
| Unroasted | 0.58 | 30.81 | 16 | 2532 | 152 |
| Rice Flour | | | | | |

Rheology Measurements were performed using a Brookfield 2.5HA-Ultra spring range viscometer equipped with a SC4-27 spindle, according to the NCA/CMA Casson model.

(Brookfield Engineering Laboratories, Inc., Middleboro, Massachusetts). The NCA/CMA Casson model is designed by the National Confectioners Association (NCSA) and the Chocolate Manufacturers Association (CMA) as the standard rheological model for the industry. This model determines yield and flow properties under specified conditions and closely approximates the plastic behavior of chocolate before final processing. When chocolate is used for enrobing, it must have a yield stress high enough to stay in place once it enrobes the filling. In the case of decorating chocolate, the yield stress must be high enough so it can keep its shape once it has been squeezed into place through a nozzle. For molding chocolate, the plastic viscosity must be low enough to completely fill the mold.

Referring to Table 4, the suspension prepared with roasted rice flour has a similar moisture content, fat content and mean particle size as the suspensions prepared with unroasted rice flour. However, the suspension prepared with roasted rice flour has improved rheological properties, particularly viscosity. The lower viscosity of the suspensions prepared with roasted rice flour provides a suspension with an improved mouth feel and improved processability compared to the suspensions prepared with unroasted flour. Accordingly, it is preferable that confections prepared in accordance with this invention have a viscosity of less than 2400 centiPoise at 40 degrees Celsius and, more preferably, between 2000 and 2200 centiPoise at 40 degrees Celsius.

Without being bound to a particular theory, it is believed that the improved viscosity, processability and mouth feel are the result of physical and or chemical changes that occur to the flour particles during the roasting process. These changes include, but are not limited to, the differences in water reactivity observed in the viscosity data of FIG. 2 and the differences in particle size distributions of the flour when processed into chocolate confections, seen in FIG. 3. A further change that has been identified is the reduced oil binding capacity of roasted grain flour compare to unroasted grain flour.

### Example 5: Oil-Binding Capacity Compared for Roasted and Unroasted Rice Flour

The oil binding capacity of roasted rice flour was measured and compared to unroasted rice flour and, for reference, rice starch and sucrose. A mineral oil was used to measure the amount of oil that was bound by each sample. The roasted rice flour was prepared according to the procedure of Example 3.

TABLE 5
Oil Binding Capacity Comparison

| | Oil-binding capacity |
|---|---|
| Ingredient | (g oil/100 g powder) |
| Roasted Rice Flour | 42.31 |
| Unroasted Rice Flour | 51.22 |
| Rice Starch (Reference) | 108.71 |
| Sucrose (Reference) | 47.62 |

Referring to the results in Table 5, the oil binding capability of the roasted flour is markedly reduced compared to the unroasted rice flour. The roasted rice flour showed a lower oil binding capability than even sucrose which is essentially a crystalline material and only binds oil on the surface of the particles. Without being bound to a particular theory, it is believed that the lower-oil binding capacity of the roasted rice flour compared to the unroasted rice flour is a factor in the improved viscosity, processability, rheology and mouthfeel of dairy-free chocolate compositions formulated using the roasted grain flour.

### Example 6—Sensory Panel Evaluation of Dairy-Free Chocolate Confections Using Roasted/Unroasted Rice Flours

Samples of the connections prepared according to the formulation of Example 4 were evaluated by a sensory panel. The sensory panel found that the sensory profile of dairy-free confections prepared using roasted rice flour were distinguishable from the dairy-free confections prepared using unroasted rice flour in both flavor and textural aspects. In regard to flavor, typical notes associated with roasting were observed in the dairy-free confections made with roasted rice flour but were not present in the confections made with unroasted rice flour. Dairy-free chocolate confections made with roasted rice flour showed greater mouth coating and mouth melt times compared to confections made with unroasted rice flour.

It is to be understood that the embodiments and examples described herein are merely exemplary and that a person skilled in the art may make many variations and modifications without departing from the spirit and scope of the invention. All such variations and modifications are intended to be included within the scope of the invention, as defined by the following claims.

What is claimed:

1. A chocolate confection comprising:
a roasted grain flour component;
a cocoa component;
a sweetener; and
a plant origin fat.

2. The chocolate confection of claim 1, wherein the chocolate is dairy-free.

3. The confection of claim 1, wherein the roasted grain flour component comprises a grain flour made from a raw grain selected from the group consisting of corn, rice, oat, wheat, sorghum, millet and combinations thereof, wherein the raw grain is ungerminated.

4. The confection of claim 1, wherein the cocoa component is selected from the group consisting of cocoa solids, cocoa powder, cocoa liquor and combinations thereof.

5. The confection of claim 1, wherein the sweetener is a nutritive sweetener selected from the group consisting of sucrose, fructose, glucose, maltose, corn syrup solids and combinations thereof.

6. The confection of claim 1, wherein the sweetener comprises one from the group consisting of maltitol, sorbitol, erythritol, allulose, tagatose, aspartame, stevia, stevia extracts, sucralose and combinations thereof.

7. The confection of claim 1, wherein the plant origin fat is selected from the group consisting of cocoa butter, palm oil, palm kernel oil, sunflower oil, shea, sal, illepe, mango kernel and combinations thereof.

8. The confection of claim 1, wherein the roasted grain flour component is roasted rice flour.

9. The confection of claim 1, wherein the roasted grain flour component comprises less than 5 percent by weight of water.

10. The confection of claim 1, wherein the roasted grain flour component comprises from 1 to 75 percent by weight of the confection.

11. (canceled)

12. The confection of claim 1 wherein the sweetener comprises from 25 to 70 percent by weight of the confection.

13. (canceled)

14. (canceled)

15. The confection of claim 1, wherein the roasted grain flour component comprises from 1 to 35 percent by weight of the confection, the sweetener comprises from 35 to 60 percent by weight of the confection, the cocoa component comprises from 12 to 35 percent by weight of the confection, and the plant origin fat comprises from 10 to 30 percent by weight of the confection.

16. (canceled)

17. The confection of claim 1, wherein the confection has a viscosity that is between 2000 and 2200 centiPoise at 40 degrees Celsius.

18. A method of making a dairy-free chocolate confection comprising:
a. roasting a grain flour made from a raw grain to a desired endpoint to produce a roasted grain flour component;
b. cooling the roasted grain flour component to below 30 degrees Celsius;
c. mixing and grinding a desired amount of the roasted grain flour with a desired amount of a sweetener, a desired amount of a cocoa component, and a desired amount of a plant origin fat, a plant-origin fat to produce a dairy-free chocolate confection.

19. The method of claim 18, wherein step a comprises roasting a grain flour made from a raw grain to an endpoint determined by measuring a degree of color change in the rice flour.

20. The method of claim 18, wherein step a comprises roasting a grain flour made from a raw grain to a desired internal temperature of the grain flour.

21. The method of claim 18, wherein step a is performed using a technique selected from air roasting, fluidized bed roasting, drum roasting, oven roasting, rotary tray roasting, coffee roasting and combinations thereof.

22. The method of claim 18 wherein step a is performed for a sufficient period of time to cause a change in color that is measurable using a colorimeter configured to measure color values on the Hunter Laboratories Color Scale.

23. The method of claim 18 wherein step a is performed for a sufficient period of time to increase an internal temperature of the grain flour to 85 degrees Celsius or greater.

24. (canceled)

25. The method of claim 18, wherein step c comprises mixing and grinding the roasted grain flour with a sweetener, a cocoa component, and a plant origin fat until a target particle size of the roasted grain flour is obtained.
